(19) United States
(12) Patent Application Publication
(10) Pub. No.: US 2013/0183565 A1
(43) Pub. Date: Jul. 18, 2013

(54) CASING FOR AN ELECTROCHEMICAL CELL

(71) Applicant: Christian Zahn, Dresden (DE)

(72) Inventor: Christian Zahn, Dresden (DE)

(73) Assignee: LI-TEC BATTERY GMBH, KAMENZ (DE)

(21) Appl. No.: 13/816,682

(22) PCT Filed: Aug. 5, 2011
(86) PCT No.: PCT/EP11/03945

§ 371 Date: Apr. 2, 2013

(30) Foreign Application Priority Data
Aug. 12, 2010 (DE) 102010034081.2

(51) Int. Cl. H01M 2/02

(52) U.S. Cl. CPC H01M 2/02
USPC 429/120

(57) ABSTRACT

An electrochemical cell comprises an electrode stack, at least one current conductor connected to the electrode stack, and a casing at least partially enclosing the electrode stack, wherein the at least one current conductor extends at least partially out of the casing. At least one heating device is integrated into the casing of the electrochemical cell which has at least one preferably areal heating zone extending at least over a sub-region of the casing.

### BACKGROUND

The invention relates to a casing for an electrochemical cell, an electrochemical cell having such a casing as well as an electrochemical energy storage means having at least one such electrochemical cell.

Batteries (primary storage means) and accumulators (secondary storage means) are known types of electrochemical storage apparatus, which are formed from one or a plurality of storage cells, in which, by means of applying a charge current, electrical energy is converted into chemical energy and thus stored in an electrochemical charge reaction between a cathode and an anode in or between an electrolyte, and in which, by connecting an electrical consumer load, chemical energy is convened into electrical energy in an electrochemical discharge reaction. Here, primary storage means are as a rule only charged once and disposed of after their discharging, while secondary storage means allow a plurality (from a few 100 to over 10 000) of charging and discharging cycles. In this context it should be noted that, especially in the automotive field, accumulators are also referred to as batteries.

The present invention is described in the context of lithium-ion batteries for the supply of automotive vehicle drives. It is pointed out that the invention can also find application independently of the chemistry and the type of construction of the electrochemical cell and the battery and also independently of the type of supplied drive.

Electrochemical cells having an electrode stack enclosed at least partially by a casing are known from the prior art. The casing should on the one hand prevent the escape of chemicals from the electrode stack into the environment and on the other hand protect the components of the cell from undesired interactions with the surroundings, for example from water or water vapor.

Furthermore it is known that the effectiveness, the charge capacity, the performance output, and the life expectancy of electrochemical storage means depend on their operating temperature. Thus irreversible chemical reactions occur during the conversion of electrical energy into chemical energy, and vice versa, which cause an ageing of the energy storage means. In addition to a faster conversion of energy, the ageing of the energy storage means is accelerated with increasing temperature within the cells of an electrochemical energy storage means. If the temperature in the cells becomes too high, there is the danger even of destruction of the energy store. Therefore various measures are known which have the purpose of cooling such an electrochemical energy storage means.

On the other hand, many electrochemical energy storage means only work efficiently and reliably above a lower operating temperature. This lower operating temperature is in particular dependent on the construction and the operating principle of the energy storage means and its cells. Therefore it can be desirable to increase an energy storage means' temperature according to the purpose, application and environmental temperature, by means of heat supply.

As shown for exemplarily in FIG. 5A, the internal resistance Ri of an electrochemical cell increases sharply at low temperatures T. This has the result that the power loss Pv of the cell increases sharply at low temperatures and the efficiency W of the cell decreases at low temperatures correspondingly as shown exemplarily in FIG. 5B.

### SUMMARY

The invention is based on the object of providing an improved electrochemical energy storage means to which heat can be supplied.

This is achieved according to the invention by means of the teaching of the independent claims. Further preferred developments of the invention are the subject of the dependent claims.

According to the invention, a casing is provided for an electrochemical cell in which at least one heating device is integrated. This at least one heating device has at least one preferably area heating zone which extends at least over as sub-region of the casing.

According to the invention, an electrochemical cell is also provided which. comprises an electrode stack, at least one current conductor which is connected to the electrode stack, and a casing according to the invention that at least partly encloses the electrode stack wherein the at least one current conductor extends at least partially out of the casing.

According to the invention, an electrochemical energy storage means is further provided that comprises a housing and at least one electrochemical cell according to the invention arranged in the housing.

According to the present invention, at least one heating device is integrated into the casing of an electrochemical cell of an electrochemical energy storage means. In this way the heating device, is arranged very close to the cell to be temperature controlled, or the cell's component parts to be temperature controlled, so that the heat produced by the heating device can be transferred as lossless as possible to the cell or its component parts. Herewith, a high efficiency of the heating device can be achieved. Also, if necessary, a homogenous temperature distribution in the cell can be achieved by means of the integration of the heating zone into the casing of the cell.

With the help of the at least one heating device integrated into the casing, the electrochemical energy storage means itself can be operated, in the event of even low environmental temperatures, at an optimal operating temperature and therefore with a high efficiency.

By means of the integration of the at least one heating device in the casing of the electrochemical cell, a compact construction of the cell can be furthermore achieved. Moreover, a separate assembly of a heating device after the manufacture of the electrochemical cell can advantageously be omitted,

Within the context of the present invention an “electrochemical energy storage means” is understood to mean any type of energy storage means from which electrical energy can be extracted, wherein an electrochemical reaction takes place in the inside of the energy storage means. The term includes energy storage means of all types, in particular primary batteries and secondary batteries. The electrochemical energy storage means has at least one electrochemical cell, preferably a plurality of electrochemical cells. The plurality of electrochemical cells can be connected in parallel for the purpose of storing a larger charge quantity, or connected in series for the purpose of realizing, a desired operating voltage, or form a combination of parallel and series connections.

Within the context of the present invention, an “electrochemical cell” or “electrochemical energy storage cell” is understood to mean an apparatus which outputs electrical energy, wherein the energy is stored in chemical form. In the case of rechargeable secondary batteries, the cell is also designed to receive electrical energy, to convert it into chemical energy, and to store it. The shape (i.e. in particular the size and the geometry) of an electrochemical cell can be chosen depending on the available space. The electrochemical cell is preferably essentially prismatically or cylindrically formed.

In this context, an “electrode stack” is understood to mean an arrangement of at least two electrodes and an electrolyte arranged in between. The electrolyte can be partly accommodated by a separator. In that case the separator separates the electrodes. The electrode stack preferably has a plurality of layers of electrodes and separators, wherein the electrodes of the same polarity are each preferably electrically connected with each other, in particular connected in parallel. The electrodes are for example configured to be plate-like or film-like and are arranged preferably essentially parallel to each other (prismatic energy storage cells). The electrode stack can also be wound and possess an essentially cylindrical shape (cylindrical energy storage cells). The term “electrode stack” should also include electrode coils of this kind. The electrode stack can include lithium or another alkali metal, also in ionic form.

Within the context of the present invention a “current conductor” is understood to mean an electrically conducting construction element of an electrochemical cell which serves the purpose of transporting electrical energy into the cell or out of the cell. Electrochemical cells usually have two types of current conductors which are each electrically conductively connected to one of the two electrodes or electrode groups—anodes or cathodes—in the interior of the cell. In other words, each electrode of the electrode stack of the cell has its own current conductor, or the electrodes of the same polarity of the electrode stack are connected with a common current conductor. The shape of the current conductor is suited to the shape of the electrochemical cell or its electrode stack.

The term “casing” should include any type of apparatus which is suited to prevent the exit of chemicals from the electrode stack into the surroundings and to protect the components of the electrode stack from damaging external influences. The casing can he designed from one or a plurality of molded parts and/or be designed to be film-like. Furthermore, the casing can be designed to have one layer or a plurality of layers. Moreover the casing can be made from an essentially stiff material or from an elastic material. In order to improve the heat supply from the integrated heating device into the inside of the electrochemical cell, the casing is—at least on its side facing the inside of the cell, preferably configured to be thermally conductive. Furthermore, the casing is preferably formed from a gas-tight and electrically insulating material or layer composite. The casing surrounds the electrode stack preferably as much possible without gaps or air pockets in order to facilitate heat transfer between the casing and the inside of the electrochemical cell.

The term “heating zone” is meant to describe the portion of the heating device in which the heating function and the heat supply into the inside of the cell take place. In this context, the term “areal” heating zone is understood to mean such heating zones that have a significant extension in two spatial directions and in this way have an efficient heat transfer surface.

According to the invention, “at least one heating device” should be integrated into the casing of the electrochemical cell. This means that preferably one, two, three, four, or more heating devices are integrated into the casing. In the case of an essentially prismatic cell which has two main sides or main surfaces, a heating device is preferably integrated, into one main side of the casing or one heating device each in one of the two main sides of the casing. Equally preferred is the integration of two heating devices in one of the two main sides or in both main sides of the casing.

In this context, the term “integration” should be understood to mean any type of integration of the heating device component in the casing component. Preferably, the integration of the heating device in the casing leads to a prefabricated component which, in the course of the manufacture of the electrochemical cell, can be dealt with as a single component. The integration is carried out by means of an appropriate manufacturing process depending in particular on the material of the casing. The connection between the at least one heating device and the casing is preferably materially connected and/or by means of a force-locking connection or a positive-fit connection. With such an integration, preferably an essentially complete enclosing of the heating device within the material of the casing is achieved. Equally preferred are a partial enclosing of the heating device within the material of the casing and at the same time arranging the heating device to be at least partially kept clear on the side facing the inside of the casing and/or on the side facing away from the inside of the casing.

Preferred developments of the invention are described in the following:

The at least one heating zone of the at least one heating device advantageously has a geometry and/or size which fits a geometry or size of the casing. This fit in geometry and/or size promotes the efficiency and the homogeneity of the heat transfer from the heating device in the casing into the inside of the electrochemical cell. With this fit, one side or surface of the casing is preferably provided as extensively as possible or even almost completely with at least one heating zone of the at least one heating device. The at least one heating device, has preferably exactly one heating zone but it can also have two or more separate or interconnected heating zones.

It is advantageous for the heating, device to have one electrical heating device. The electrical heating device is easy to control and to realize in as simple and compact construction. The term “electrical heating device” includes all heating devices which are designed to convert electrical energy into thermal energy. The electrical heating device preferably comprises a heated wire, heated film or suchlike. In other configurations, the heating, device comprises a thermally conductive material that makes thermally conductive contact with a heat source, fluid channels for passing a hot fluid or suchlike.

It is advantageous for the heating, device to have at least one heating zone which extends essentially inside one plane within, the casing. By means of the arrangement of the heating zone of the heating device within one plane, a very compact construction of the casing having an integrated heating device can be achieved. In this context, the arrangement of at least one heating zone “within one plane” should be understood to mean an essentially single layer or single ply arrangement.

It is advantageous for the heating device to have at least one supply connection which is essentially arranged in the plane of the heating zone of the heating device. By means of the arrangement of the at least one supply connection in the plane of the heating zone of the heating device, a compact construction of the electrochemical cell can be achieved. In this context a “supply connection” should be understood to mean any type of terminal which makes available to the heating device the supply (for example electrical current, fluid flow etc.) which appropriate for the heating device. Preferably one or a plurality of supply connections are provided according to type and number of heating devices.

It is advantageous for the casing to have one main surface and for the heating zone/s of the at least one heating device of the casing to extend essentially over the entire main surface. In the case of an essentially prismatic cell, the casing has two essentially rectangular main surfaces which have the largest surface extent of the in total six surfaces or sides of the cell. In the case of an essentially cylindrical cell, the casing has a cylindrical surface as its main surface.

When the electrochemical energy storage means has at least two electrochemical cells, it is advantageous for all electrochemical cells of the energy storage means to be designed according to the above described invention i.e. to be provided with a casing with an integrated heating device. In this way a homogenous thermal distribution over the entire energy storage means can be achieved.

The energy storage means preferably has at least one terminal element which is connected with the current conductor of the electrochemical cell or the current conductors of the electrochemical cells, wherein the at least one terminal element extends at least partially out of the housing. In one configuration, the electrical heating device(s) of the casing(s) of the electrochemical cell(s) is/are connected or connectable to said terminal element. With this construction, the electrochemical energy storage means can itself operate the heating devices in the electrochemical cells, in this case, the electrical heating devices are preferably configured for the battery voltage of the electrochemical energy storage means. This configuration allows also the implementation of a heating algorithm for a permanent heat supply into the inside of the cells.

It is advantageous for the energy storage means to have a further terminal element which is connected or connectable with the supply connection of the at least one heating device of the electrochemical cell or the supply connections of the heating devices of the electrochemical cells, wherein this at least one further terminal element extends at least partially out of the housing. This configuration is applicable for electrical heating devices as well as for other heating devices and allows the operation of the heating devices independent of the operational state of the electrochemical energy storage means.

In one configuration, the electrochemical energy storage means comprises at least one terminal element and at least one further terminal element. In this case it is advantageous to provide for a switching device for switching between the connection with the terminal element and the connection with the further terminal element. In this way the electrical heating devices can be operated selectively either by the energy storage means itself or through an external current source.

It is advantageous for the heating device(s) of the casing(s) of the electrochemical cell(s) to be controllable by a battery management system (BMS) of the energy storage means. The battery management system is preferably integrated into the electrochemical energy storage means. In another configuration, the battery management system is provided outside the energy storage means. Furthermore, the battery management system forms preferably a unit with the energy storage means. In this context, “battery management system” is an apparatus for monitoring and controlling the electrochemical energy storage means and in particular its electrochemical cell. Among the tasks of the battery management system are preferably: control of the charging and discharging procedures, temperature monitoring, evaluating the charge capacity, monitoring of the cell voltages and suchlike. With the help of the battery management system, preferably an optimal operating behavior of the energy storage means should be achieved in order to realize as much of an improvement as possible in the endurance, range and reliability of said energy storage means. Here, the battery management system preferably suits the configuration of the electrochemical energy storage and its electrochemical cells. Furthermore, the battery management system is preferably connected with the control unit of a motor vehicle, for example.

Further advantages, features and application possibilities of the present invention are revealed in the following description of preferred embodiments in connection with the figures. In the figures;

### BRIEF DESCRIPTION OF THE DRAWINGS

FIG. 1 shows a schematic cross-sectional view of an electrochemical cell for an electrochemical energy storage means according to a first preferred embodiment of the present invention;

FIG. 2 shows a schematic side view of the electrochemical cell of FIG. 1 according to view A according to a preferred embodiment of the present invention;

FIG. 3 shows a schematic cross-sectional view of an electrochemical cell for an electrochemical energy storage means according to a second preferred embodiment of the present invention;

FIG. 4 shows a schematic cross-sectional view of an electrochemical energy storage means with a plurality of cells, which, for example, are designed according to FIG. 1 or 3, according to a preferred embodiment of the present invention; and

FIG. 5 shows an exemplary internal resistance-temperature graph, an exemplary power loss-temperature graph, and an exemplary effectiveness-temperature graph of an electrochemical cell.

### DETAILED DESCRIPTION OF ILLUSTRATED EMBODIMENTS

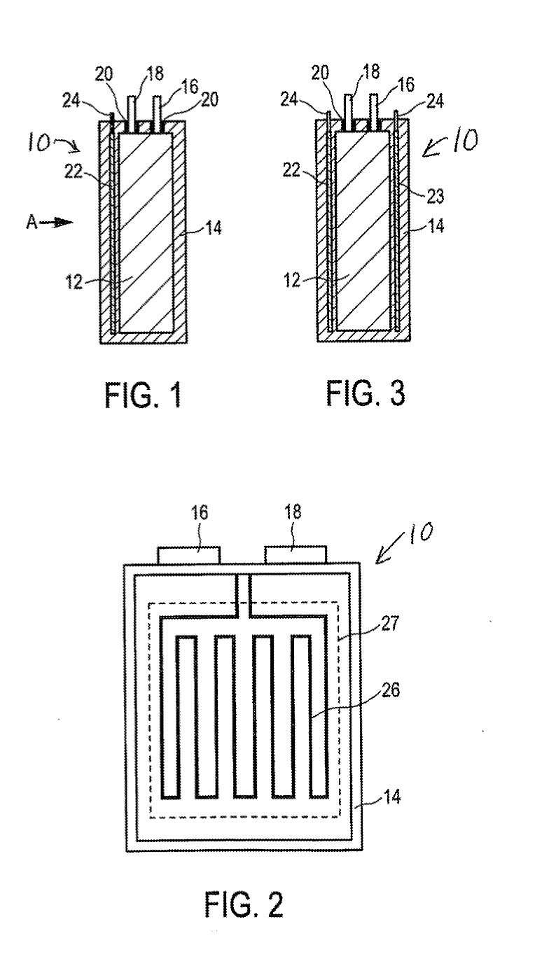

FIG. 1 shows the construction of an electrochemical cell 10 according to the invention. The cell 10 comprises at least one electrode stack 12, which is enclosed by a casing 14. The electrode stack 12 comprises a plurality of layers of electrodes and separators arranged in between said electrodes, wherein an electrolyte is at least partially accommodated by the separators.

The electrodes of one polarity are connected with a first current conductor 16 and the electrodes of the other polarity are connected with a second current conductor 18. Both the current conductors 16, 18 extend out of the casing 14, wherein a sealing area 20 is provided in the passageway area of the current conductors 16, 18.

In the embodiment of FIG. 1, the electrochemical cell 10 is designed essentially prismatically and has two main surfaces or main sides (right and left in FIG. 1). An electrical heating device 22 is integrated into the one main surface of the casing 14 (left in FIG. 1). This electrical heating device 22 is designed with a supply connection 24, in order to be able to deliver current to the heating device 22.

As shown in the side view of FIG. 2, the electrical heating device 22 comprises a heating wire 26 which is laid in a loop. This loop of the heated wire 26 defines a heating zone 27 which extends over a majority of the one main surface of the casing 14. Form and site of the heating zone 27 are in this way suited to the main surface of the casing 14.

The heated wire 26 of the electrical heating device 22 is essentially arranged inside one plane within the casing 14 of the cell 10 and forms an areal heating zone 27. The supply connection 24 of the heating device 22 is disposed essentially in the plane of the heating zone 27 or of the heated wire 26. The casing 14 with integrated electrical heating device 22 requires only negligible extra space compared to a conventional casing without such heating device 22,

In order to achieve a good heat supply from the electrical heating device 22 into the inside of the electrochemical cell 10, the casing 14 should possess at least on its inner side facing the electrode stack 12 a high thermal conductivity.

FIG. 3 shows an electrochemical cell 10 according to a second embodiment. While in the first embodiment of FIG. 1 only one main surface of the casing 14 is designed with an integrated electrical heating device 22, in the case of the electrochemical cell 10 of FIG. 3, at least one heating device 22, 23 is each integrated into the two main surfaces of the casing 14, Here, both heating, devices 22, 23 are formed essentially from a heated wire 26 which is laid so as to form an areal heating zone 27 in a loop, as illustrated in FIG. 2,

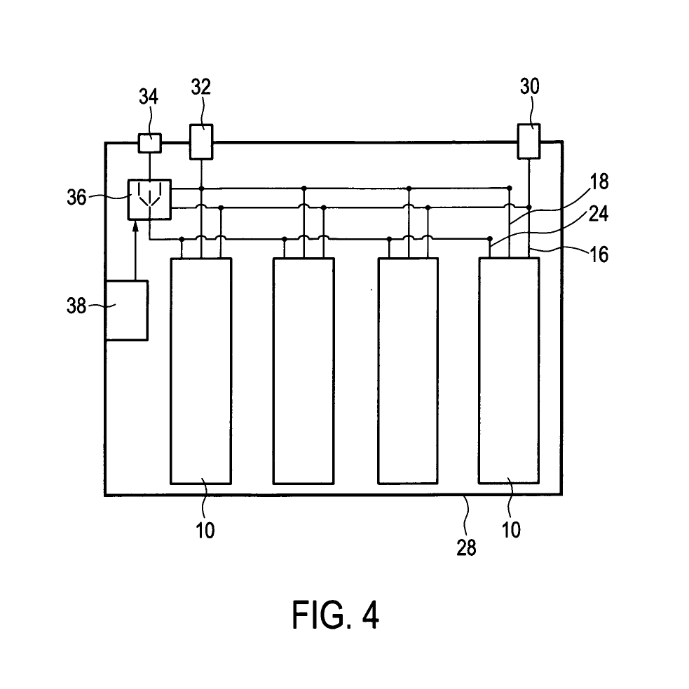

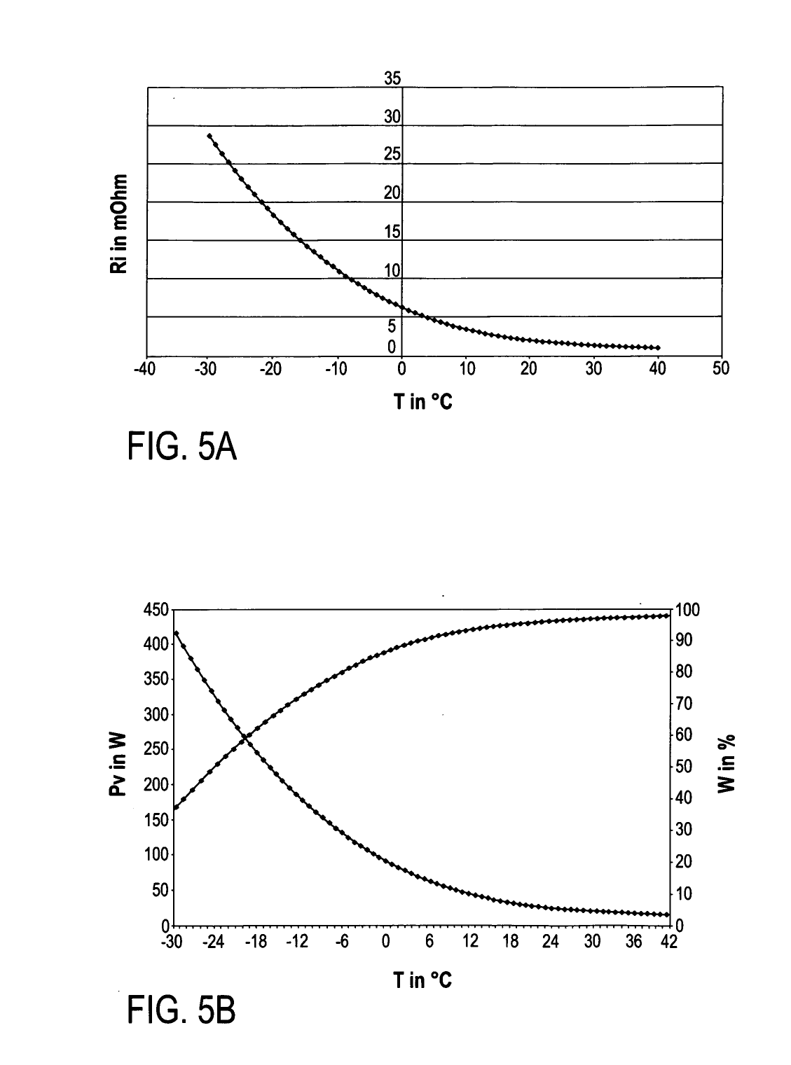

An electrochemical energy storage means, for example a secondary battery, has a housing 28, in which a plurality of electrochemical cells 10 are arranged and connected either in parallel and/or in series with each other, as shown in FIG. 4. The cells of FIG. 1 or the cells of FIG. 3 for example can be used as electrochemical cells.

The first current conductors 16 of the electrode stacks 12 of the plurality of cells 10 are electrically conductively connected with a first terminal element 30 (e.g. plus pole), while the second current conductors 18 of the electrode stacks 12 of the plurality of cells 10 are electrically conductively connected with a second terminal element 32 (e.g. minus pole). Both the two terminal elements 30, 32 extend partially out of the housing 28 of the energy storage means, in order to be able to connect an electrical consumer load or a charging apparatus.

In the embodiment of FIG. 4, the energy storage means further comprises at least one further terminal element 34 which is electrically conductively connected with the supply connections 24 of the heating device 22 of the electrochemical cells 10. This further terminal element 34 also extends partially out of the housing 28 of the energy storage means, in order to be able to connect a current source.

Moreover, the supply connections 24 of the heating devices 22 of the cells 10 are electrically conductively connected with the terminal elements or poles 30, 32 of the energy storage means in the inside of the housing 28. The electrical heating devices 22 can in this way be supplied with electrical energy by the electrochemical energy storage means itself.

In addition, a battery management system (BMS) 38 is arranged in the housing 28 of the electrochemical energy storage means. In addition to monitoring and control functions of the cells 10, this BMS 38 also has the task to control the electrical heating devices 22 of the cells 10. To this aim the BMS 38 controls a switching apparatus 36 in the housing 28, which creates, according to necessity, an electrical connection of the supply connections 24 of the electrical heating device 22 selectively with the poles 30, 32 of the energy storage means or with the further terminal element 34 of the energy storage means.

While in the embodiment of FIG. 4, the supply connections 24 of the electrical heating devices 22 of the cells 10 can either be connected with the poles 30, 32 of the energy storage means or with the further terminal element 34, also only one of these two alternatives can be made available. In this case the switching apparatus 36 has no switching function any more, rather only a simple powering-up function which is controlled by the BMS 38.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing, from the spirit or scope of the applicant's general inventive concept.

1.-13. (canceled)

14. A casing for an electrochemical cell, comprising:
a heating device integrated into the casing; and
an areal heating zone of the heating device, the areal zone extending over a sub-region of the casing.

15. The casing according to claim 14, wherein:
the areal heating zone of the heating device has at least one of a geometry and a size which fits at least one of a geometry and a size of the casing.

16. The casing according to claim 14, wherein:
the heating device comprises an electrical heating device.

17. The casing according to claim 14, wherein
the heating zone extends substantially within one plane in the casing.

18. The casing according to claim 17, wherein:
the heating device includes at least one supply connection; and
the at least one supply connection is arranged substantially in the plane of the heating zone.

19. An electrochemical cell comprising:
an electrode stack;
at least one current conductor connected to the electrode stack; and
a casing at least partially enclosing the electrode stack;
wherein the at least one current conductor extends at least partially out of the casing; and
the casing includes:
a heating device, the heating device including an areal heating zone that extends at least over a sub-region of the casing.

20. The electrochemical cell according to claim 19, wherein:
the heating device is integrated into the casing.

21. The electrochemical cell according to claim 19, wherein:
the casing includes a main face; and
the heating zone extends substantially entirely over the main face.

22. The electrochemical cell according to claim 19, wherein:
the electrochemical cell is arranged in a housing.

23. An electrochemical energy store, comprising:
a housing; and
at least one electrochemical cell in the housing, each of the at least one electrochemical cells including:
an electrode stack;
at least one first current conductor of a first polarity connected to the electrode stack;
at least one second current conductor of a second polarity connected to the electrode stack; and
a casing, including a main face, at least partially enclosing the electrode stack;
wherein the at least one first and second current conductors extend at least partially out of the casing; and
the casing includes:
a heating device including at least one areal heating zone that extends substantially entirely over the main face and at least over a sub-region of the casing.

24. The electrochemical energy store according to claim 23, wherein:
the heating device is integrated into the casing.

25. The electrochemical energy store according to claim 23, wherein:
the energy store comprises at least two of the electrochemical cells.

26. The electrochemical energy store according to claim 25, further including:
a first terminal element, connected to each of the at least one first current conductors, extending at least partially out of the housing;
a second terminal element, connected to each of the at least one second current conductors, extending at least partially out of the housing; and
each of the heating devices is connectable to the first and second terminal elements.

27. The electrochemical energy store according to claim 26, wherein:
each of the electrochemical cells includes:
a supply connection to the heating device;
the electrochemical energy store further includes:
an additional terminal element connectable to each of the supply connections, the additional terminal element extending at least partially out of the housing.

28. The electrochemical energy store according to claim 27, further including
a switching apparatus to switch between a connection with the first and second terminal elements and a connection with the additional terminal element.

29. The electrochemical energy store according to claim 28 further including:
a battery management system;
wherein each of the heating devices is controllable by the battery management system.

30. The electrochemical energy store according to claim 29 wherein:
the battery management system is connected to the switching apparatus.

31. The electrochemical energy store according to claim 29 wherein:
the battery management system controls the switching apparatus for switching between electrically connecting each of the supply connections with one of i) the first and second terminal elements and ii) the additional terminal element.
